(19) United States
(12) Patent Application Publication
(10) Pub. No.: US 2016/0099761 A1
(43) Pub. Date: Apr. 7, 2016

(54) Beam Synchronization Methods for Beamforming Wireless Networks

(71) Applicant: MEDIATEK INC., Hsinchu (TW)

(72) Inventors: Ju-Ya Chen, Kaohsiung City (TW); York Ted Su, Chia-Yi City (TW)

(21) Appl. No.: 14/865,125

(22) Filed: Sep. 25, 2015

Related U.S. Application Data
(60) Provisional application No. 62/060,778, filed on Oct. 7, 2014.

(51) Int. Cl. H04B 7/04; H04B 7/06; H04W 56/00; H04W 40/24

(52) U.S. Cl. CPC H04B 7/0408; H04W 40/244; H04B 7/0617; H04W 56/001

(57) ABSTRACT

Inter-cell coordination to avoid/minimize inter-cell interference in a beamformed mmWave network is proposed to enhance the detection probability of beam pattern indicator. A base station first obtains beacon signal transmission information of neighboring base stations. A plurality of beacon signals are transmitted over a plurality of control beams from the neighboring base stations. The base station then determines beacon signal transmission configuration by coordinating with the neighboring base stations to minimize inter-cell beacon signal interference. Each control beam is configured with a set of periodically allocated resource blocks and a set of beamforming weights. Finally, the base station transmits beacon signals based on the determined beacon signal transmission configuration over the plurality of control beams.

### CROSS REFERENCE TO RELATED APPLICATIONS

This application claims priority under 35 U.S.C. §119 from U.S. Provisional Application No. 62/060,778, entitled “Beam Synchronization Methods for Wireless Networks,” filed on Oct. 7, 2014; the subject matter of which is incorporated herein by reference.

### TECHNICAL FIELD

The disclosed embodiments relate generally to wireless communication, and, more particularly, to beam synchronization and inter-cell coordination in a Millimeter Wave (mmW) beamforming system.

### BACKGROUND

The bandwidth shortage increasingly experienced by mobile carriers has motivated the exploration of the underutilized Millimeter Wave (mmWave) frequency spectrum between 3G and 300G Hz for the next generation broadband cellular communication networks. The available spectrum of mmWave band is two hundred times greater than the conventional cellular system. The mmWave wireless network uses directional communications with narrow beams and can support multi-gigabit data rate. The underutilized bandwidth of the mmWave spectrum has wavelengths ranging from 1 mm to 100 mm. The very small wavelengths of the mmWave spectrum enable large number of miniaturized antennas to be placed in a small area. Such miniaturized antenna system can produce high beamforming gains through electrically steerable arrays generating directional transmissions.

With recent advances in mmWave semiconductor circuitry, mmWave wireless system has become a promising solution for real implementation. However, the heavy reliance on directional transmissions and the vulnerability of the propagation environment present particular challenges for the mmWave network. The use of directional antenna or through array-based beamforming is required to compensate for server path loss. Spatial domain multiple access is used in conjunction with other multiple access schemes. In general, maintaining antenna pointing and tracking accuracy becomes essential in many phases of communication process, including operations depending on the control channels.

A base station (BS) broadcasts beacon signals in control channels with spatial-domain beam pattern for cell search and handover applications. The beacon signals have relative large beamwidth with overlapping successive beams. The beacon signal contains a beam position indication number. After a BS receiving feedback from a user equipment (UE), the BS will be able to locate the UE direction. The beacon signal is periodic with a small duty cycle instead of a constantly broadcasting signal. The periodicity of broadcasting the beacon signal for all BSs may be the same. However, a UE often receives co-channel beacon signals from multiple neighboring cells. If these beacon signals are not coordinated in time-frequency-spatial domain, inter-cell beacon interference (beacon contamination, BC) will limit the performance of the cell search and various control channel related operations, including synchronization, handover, antenna pointing and tracking, etc.

A solution for coordinating beacon signals from different base stations to avoid/minimize inter-cell interference in mmWave beamforming systems is sought.

### SUMMARY

Inter-cell coordination to avoid/minimize inter-cell interference in a beamformed mmWave network is proposed to enhance the detection probability of beam pattern indicator. A base station first obtains beacon signal transmission information of neighboring base stations. A plurality of beacon signals are transmitted over a plurality of control beams from the neighboring base stations. The base station then determines beacon signal transmission configuration by coordinating with the neighboring base stations to minimize inter-cell beacon signal interference. Each control beam is configured with a set of periodically allocated resource blocks and a set of beamforming weights. Finally, the base station transmits beacon signals based on the determined beacon signal transmission configuration over the plurality of control beams.

The beacon signal transmission information and configuration comprises beam pattern/ID information, a beacon period, and a beam sweeping order. In a first embodiment, the beacon signal transmission information is obtained based on a common external clock. In a second embodiment, the beacon signal transmission information is obtained from scanning the beacon signals from one of the neighboring base stations. In a third embodiment, the beacon signal transmission information is obtained from scanning the beacon signals from each of the neighboring base stations during an observation period. The base station detects radio signal quality or power information of each beacon signal and thereby determining a beacon period and a beam sweeping order to minimize inter-cell spatial interference among beacon signal transmissions from different cells.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a beamforming mmWave mobile communication network with inter-cell beam coordination in accordance with one novel aspect.

FIG. 2 is a simplified block diagram of a base station and a user equipment that carry certain embodiments of the present invention.

FIG. 3 illustrates a first embodiment of inter-cell control beam coordination for beacon signal transmission in a beamforming mmWave system.

FIG. 4 illustrates a second embodiment of inter-cell control beam coordination for beacon signal transmission in a beamforming mmWave system.

FIG. 5 illustrates a third embodiment of inter-cell control beam coordination for beacon signal transmission in a beamforming mmWave system.

FIG. 6 illustrates a procedure of inter-cell beam coordination for beacon signal transmission in a beamforming mmWave system.

FIG. 7 is a flow chart of a method of inter-cell beam coordination in a beamformed mmWave system in accordance with one novel aspect.

### DETAILED DESCRIPTION

Reference will now be made in detail to some embodiments of the invention, examples of which are illustrated in the accompanying drawings.

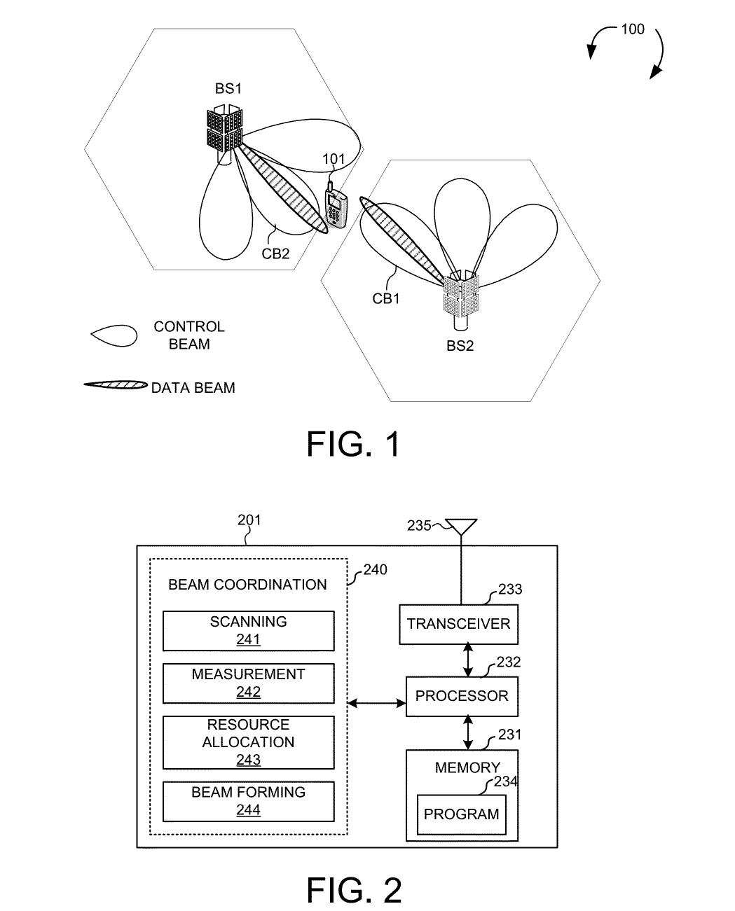

FIG. 1 illustrates a beamforming mmWave mobile communication network 100 with inter-cell beam coordination in accordance with one novel aspect. Beamforming mmWave mobile communication network 100 comprises a plurality of base stations (BSs) including a first BS1 and a second BS2 serving a plurality of small cells. The mmWave cellular network uses directional communications with narrow beams and can support multi-gigabit data rate. Directional communications are achieved via digital and/or analog beamforming, wherein multiple antenna elements are applied with multiple sets of beamforming weights to form multiple beams. For example, BS1 and BS2 are both directionally configured with multiple cells, and each cell is covered by a set of coarse resolution control beams. Each control beam in turn is covered by a set of fine resolution dedicated data beams.

A base station (BS) broadcasts beacon signals in control channels with spatial-domain control beam pattern for cell search and handover applications. Each control beam broadcasts minimum amount of cell-specific and beam-specific information similar to System Information Block (SIB) or Master Information Block (MIB) in LTE systems. Each control beam may also carry UE-specific control or data traffic. Each control beam transmits a set of known beacon signals for the purpose of initial time-frequency synchronization, identification of the control beam that transmits the beacon signals, and measurement of radio channel quality for the control beam that transmits the beacon signals.

In the example of FIG. 1, UE 101 is located within the cell coverage served by BS1, and receives beacon signal transmitted by BS1 over a control channel using control beam CB2. However, UE 101 also receives beacon signal transmitted by BS2 over a control channel using control beam CB1. If these beacon signals are not coordinated in time-frequency-spatial domain, inter-cell beacon interference (beacon contamination, BC) will limit the performance of the cell search and various control channel related operations, including synchronization, handover, antenna pointing and tracking, etc.

In accordance with one novel aspect, a solution of inter-cell coordination for beacon signal transmission is proposed. All neighboring base stations coordinate control beam transmission for beacon signals with each other. The coordination can be achieved by beam alignment among different base stations, or adjusting transmitting power from base stations. The criterion for coordination can be based on inter-cell interference avoidance or inter-cell interference minimization.

FIG. 2 is a simplified block diagram of a base station BS 201 that carry certain embodiments of the present invention. BS 201 has an antenna array 235 with multiple antenna elements, which transmits and receives radio signals. A radio frequency (RF) transceiver module 233, coupled with the antenna, receives RF signals from antenna 235, converts them to baseband signals and sends them to processor 232. RF transceiver 233 also converts received baseband signals from processor 232, converts them to RF signals, and sends out to antenna 235. Processor 232 processes the received baseband signals and invokes different functional modules to perform features in BS 201. Memory 231 stores program instructions and data 234 to control the operations of BS 201.

BS 201 also includes function modules that carry out different tasks in accordance with embodiments of the current invention. The functional modules are circuits that can be implemented and configured by hardware, firmware, software, and any combination thereof. For example, BS 201 comprises a beam coordination circuit 240 that performs control beam coordination with neighboring base stations for inter-cell interference mitigation. Beam coordination circuit 240 further comprises a scanning circuit 241 that listens to beacon signals and collects beam pattern information from neighboring base stations, a measurement circuit 242 that performs radio signal measurement (RSRP/RSRQ, SNR/SINR) of the received beacon signals, a resource allocation circuit 243 that allocates resource blocks for corresponding beam transmission, and a beam forming circuit 244 that applies various beamforming weights for different beam patterns over the allocated resource blocks. Based on the scanning and the measurement results, beam coordination circuit 240 coordinates beam configuration with neighbor cells to reduce inter-cell interference for beacon signals.

Different multiplexing schemes can be applied for control beam coordination among neighboring cells, e.g., Time Division Multiplexing (TDM), Spatial Division Multiplexing, Frequency Division Multiplexing, and Code Division Multiplexing. Taking the TDM-separated control beam (CB) transmission in each cell for example, different cells may interfere with each other at UE side, causing high UE efforts for monitoring if not properly planned (pre-determined) or (dynamically) coordinated. In general, for TDM with overlapping CB periods, then other separations, e.g., FDM, CDM, or SDM may be applied among neighboring cells to avoid or to minimize inter-cell mutual interference for beacon signals.

Asynchronous neighbor-cell control beam transmission prevents mutual interference at the cost of higher UE efforts for monitoring, because the asynchronous CB transmission requires long scanning time and more power consumption at UE side. On the other hand, synchronous control beam transmission has overlapping CB periods among neighbor cells, hence UEs may suffer from inter-cell interference. However, if the synchronous control beam transmission has non-overlapping spatial coverage, then inter-cell interference can be reduced. More specifically, the control beam pattern (e.g., the beacon period and the beam sweeping order) among neighbor cells can be coordinated to achieve SDM with non-overlapping spatial coverage of the CB transmission.

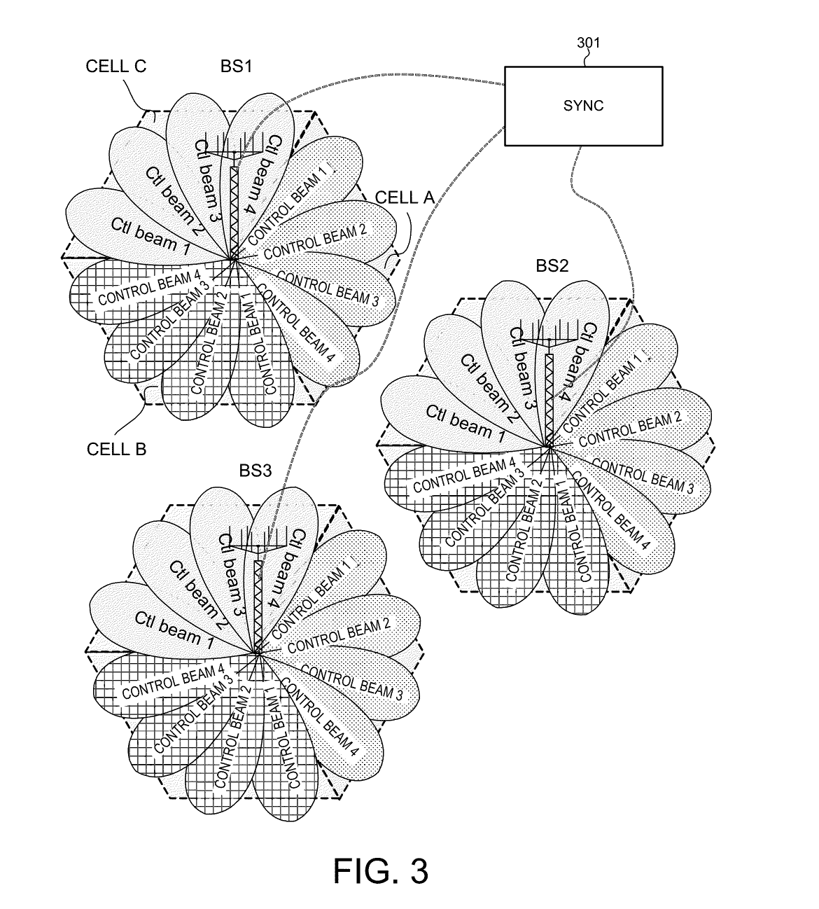

FIG. 3 illustrates a first embodiment of inter-cell control beam coordination for beacon signal transmission in a beamforming mmWave system. As shown in FIG. 3, each base station is directionally configured with multiple cells, and each cell is covered by a set of coarse TX/RX control beams. For example, a serving cell is covered by four control beams CB1 to CB4. Each control beam comprises a set of downlink resource blocks, a set of uplink resource blocks, and a set of associated beamforming weights with moderate beamforming gain. The periodically configured control beams are time division multiplexed (TDM) in time domain. Each control beam broadcasts beacon signals via the control beams. To solve the problem of inter-cell beacon interference (beacon contamination), the time slots of beacon signals from different base stations are coordinated.

In the embodiment of FIG. 3, base stations are synchronized by using a common external clock, i.e., GPS, or through some intra-network synchronization process as depicted by SYNC 301. Beacon signal transmission configuration is predefined in the network based on the common clock. The beacon periods and resources for beacon signal transmission are the same for every base station. The beacon sweeping order via the control beams is the same for all base stations. The beacon signal is rotated (switched) sequentially over the range of interest. For example, each base station BS1, BS2, and BS3 has the same beacon periodicity and starting time for beacon transmission. At the beginning of each beacon period, each BS transmits beacon signals over CB1, CB2, CB3, and CB4 for cell A, followed by beacon signals over CB1, CB2, CB3 and CB4 for cell B, and followed by beacon signals over CB1, CB2, CB3 and CB4 for cell C. In an alternative example, each base station transmits beacon signals over CB1, CB2, CB3, and CB4 for cell A, cell B, and cell C simultaneously. This may require the BSs being equipped with multiple RF chains so that they are capable of TX/RX over multiple beams simultaneously.

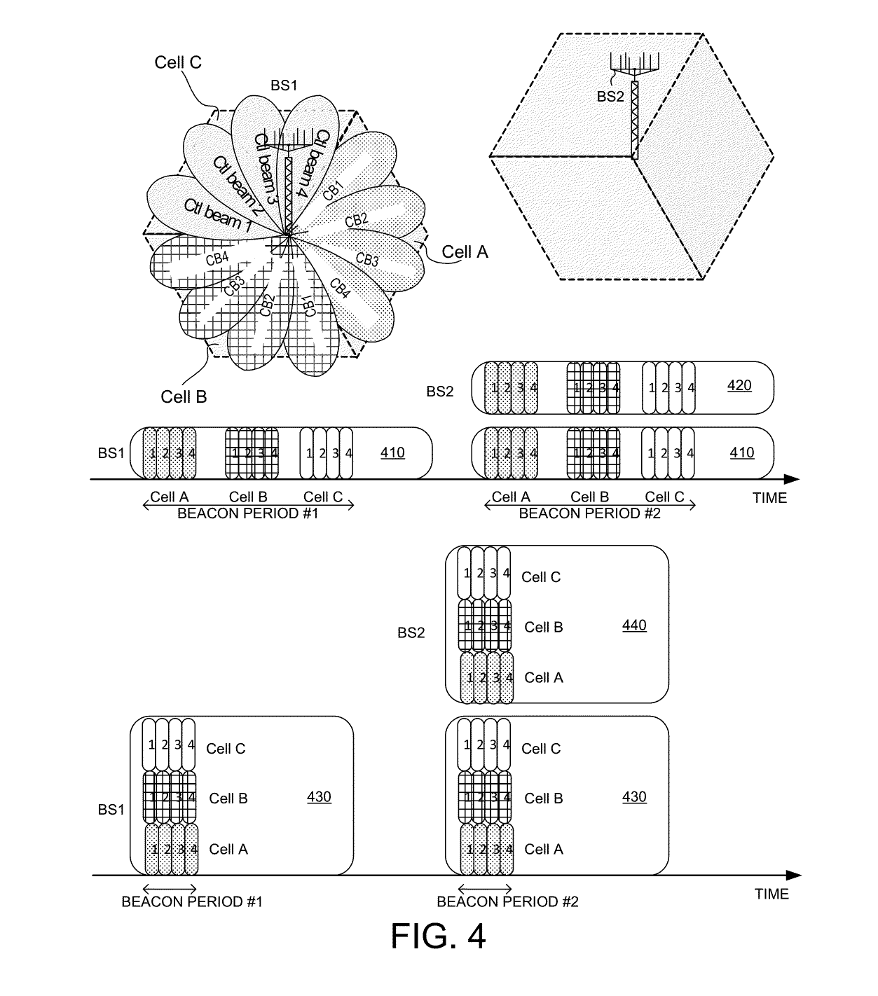

FIG. 4 illustrates a second embodiment of inter-cell control beam coordination for beacon signal transmission in a beamforming mmWave system. In the example of FIG. 4, a new base station BS2 is joining an existing network, which includes BS1 and some other neighboring base stations. All the existing control beams for beacon transmission are switched (rotated) sequentially or clockwise or counter-clockwise during fixed beacon periods based on predefined rules. Each newly joined BS needs to obtain the beacon transmission information and synchronize to the existing network.

In one example, as depicted by box 410 of FIG. 4, BS1 and other neighboring base stations transmit beacon signals during each beacon periods (e.g., periods #1 and #2) over CB1, CB2, CB3, and CB4 for cell A, Cell B, and Cell C, respectively. When new BS2 joins the exiting network, BS2 listens to the beacon signals and collects the associated beam pattern indicator/ID information from its neighboring BSs. BS2 then uses the sensed information and the beacon period to detect the beam sweeping order and tries to synchronize with the exiting network. At the beginning of the next beacon period (e.g., period #2), BS2 stats sending its own beacon signals. As depicted by box 420, the beacon signal transmission from newly joined base station BS2 is synchronized with the beacon signal transmission from BS1.

In another example, as depicted by box 430 of FIG. 4, BS1 and other neighboring base stations transmit beacon signals during each beacon periods (e.g., periods #1 and #2) over CB1, CB2, CB3, and CB4 for cell A, Cell B, and Cell C simultaneously. When new BS2 joins the exiting network, BS2 listens to the beacon signals and collects the associated beam pattern indicator/ID information from its neighboring BSs. BS2 then uses the sensed information and the beacon period to detect the beam sweeping order and tries to synchronize with the exiting network. At the beginning of the next beacon period (e.g., period #2), BS2 stats sending its own beacon signals. As depicted by box 440, the beacon signal transmission from newly joined base station BS2 is synchronized with the beacon signal transmission from BS1.

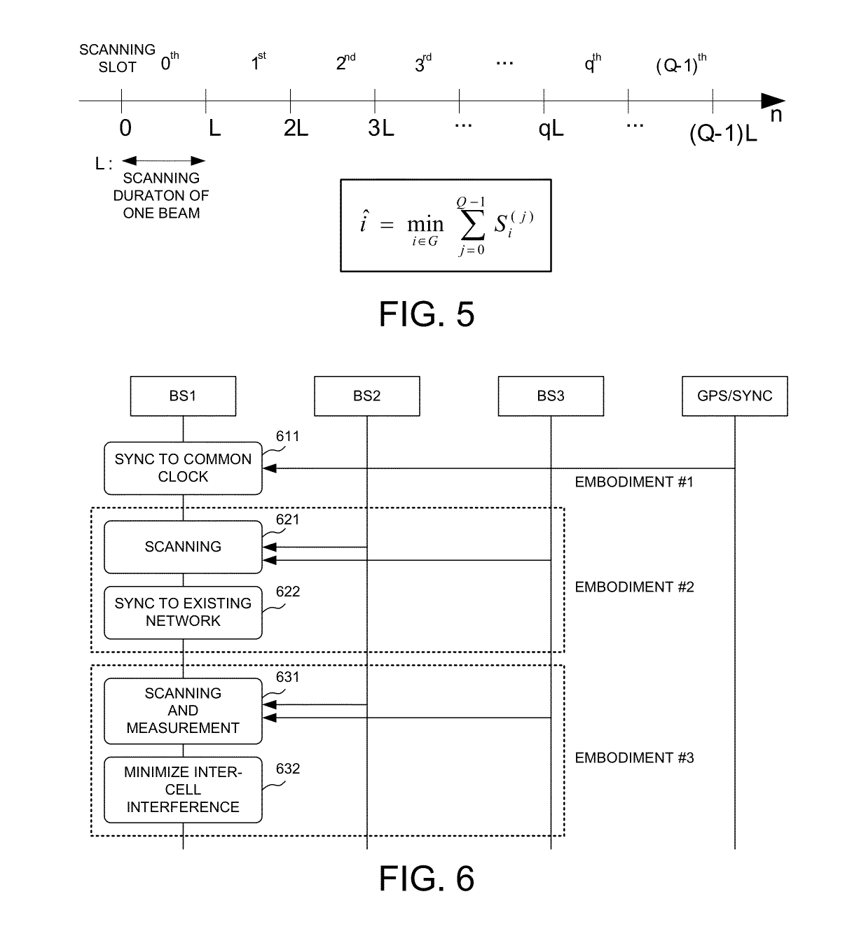

FIG. 5 illustrates a third embodiment of inter-cell control beam coordination for beacon signal transmission in a beamforming mmWave system. In this embodiment, a new BS joins an existing network. The control beam transmission of the existing network can be swept sequentially or in a specified order. The newly joined BS listens to the existing beacon transmission and configure its own beam patterns to minimize mutual interference. This method is suitable for both synchronous and asynchronous networks.

More specifically, the new BS listens to the beacon signals and collects the associated SNR/SINR/power information Sᵢ^{(q)} of all the beam pattern indicators/IDs from all neighboring base station in an observation duration. In one example, the receiving beacon signal information Sᵢ^{(q)} can be obtained by manipulating the received signal r(n) for observation duration mN≧n≧(m+1)N−1:

$$\begin{matrix}{S}_{i}^{( 0 )} = f ( r ( 0 + mN ) , r ( 1 + mN ) , … , r ( L - 1 + mN ) ) \\ … \\ {S}_{i}^{( q )} = f ( r ( ( q - 1 ) L + mN , r ( ( q - 1 ) L + 1 + mN , … , r ( qL - 1 + mN ) ) \\ … \\ {S}_{i}^{( Q - 1 )} = f ( r ( Q - 2 ) L + mN , r ( ( Q - 2 ) L + 1 + mN , … , r ( ( Q - 1 ) L - 1 + mN ) )\end{matrix}$$

### Where

n is sampling time
N is observation period, can be the same as beam scanning period.
m is any integer
i is beam pattern indicator, 0≦i≦J−1.
q is control beam slot number, 0≦q≦Q−1. In general, J can be equal to Q.
L is the scanning duration for each control beam pattern.
K is the total beam scanning duration, starting time is at the beginning of beam scanning period, K=LQ

The new BS defines a set G as Q elements permutation from {0, 1 . . . J−1}. There are a total of P(J,Q) possible permutations. The new BS then finds an optimum solution for transmitting beam pattern order based on:

$$\hat{i} = {min}_{i ∈ G} {\sum }_{j = 0}^{Q - 1} {S}_{i}^{( j )}$$

FIG. 6 illustrates a procedure of inter-cell beam coordination for beacon signal transmission in a beamforming mmWave system. Depending on backhaul communications and operator policies, a neighboring mmWave cell may be synchronous or asynchronous to a serving mmWave cell. For asynchronous neighboring cells, their beacon signal transmission periods can be different. For synchronous neighboring cells, their beacon signal transmission periods can be overlapping (e.g., with reference to GPS). In general, for synchronous CB transmission, the beam sweeping order among different neighboring cells shall be coordinated to achieve non-overlapping spatial coverage (e.g., SDM). Furthermore, FDM and/or CDM can be combined with TDM/SDM schemes to reduce inter-cell interference.

In a first embodiment, in step 611, all BSs including BS1 having overlapping beacon signal transmission based on an external common clock (e.g., with reference to GPS), or through some intra-network synchronization process (e.g., with reference to SYNC). The beam sweeping order among different neighboring cells are coordinated to achieve non-overlapping spatial coverage (e.g., SDM) to avoid inter-cell interference.

In a second embodiment, individual BSs can learn this timing synchronicity information of their neighboring cells via scanning, BS-BS signaling, from operators, or following some pre-determined or otherwise random pattern per network planning. A new or existing BS can also follow operator policies to coordinate their pre-determined or random beam pattern that includes periodicity, synchronicity, and sweeping order of control beams. In one example, in step 621, new BS1 performs scanning for beacon signals transmitted from the existing network (e.g., BS2 and BS3). In step 622, BS1 uses the sensed information and beacon period to detect the beam sweeping order and synchronize with the existing network. In case of severe mutual interference, a UE cannot resolve any control beam for connection establishment. In order to minimize beam collision probability at the UE, the rotation of beam sweeping direction/order should be different among neighboring BSs. The coordinated neighboring cells beam sweeping direction/order avoids inter-cell interference for the beacon signals.

In a third embodiment, when a new BS1 joins the network, BS1 can configure its own beam patterns to minimize mutual interference. Note that inter-BS coordination and change of control beam transmission configuration should be a rare event, which is preferably applied for a new cell entering a stable network. The new cell may select an initial transmission order randomly or predetermined, and then collect beacon signal transmission information for coordination before control beam transmission order is changed. After convergent, the mutual interference situation is stable and preferably no change is conducted. In one example, in step 631, new BS1 performs scanning for beacon signals transmitted from the existing network (e.g., BS2 and BS3) during an observation period. BS1 also performs measurements on the received beacon signals (e.g., SNR/SINR or power) for the observation period. In step 632, BS1 defines possible permutations for beam pattern configuration and then determines its own beacon period and beam-sweeping order to minimize mutual interference based on beacon signal measurement results.

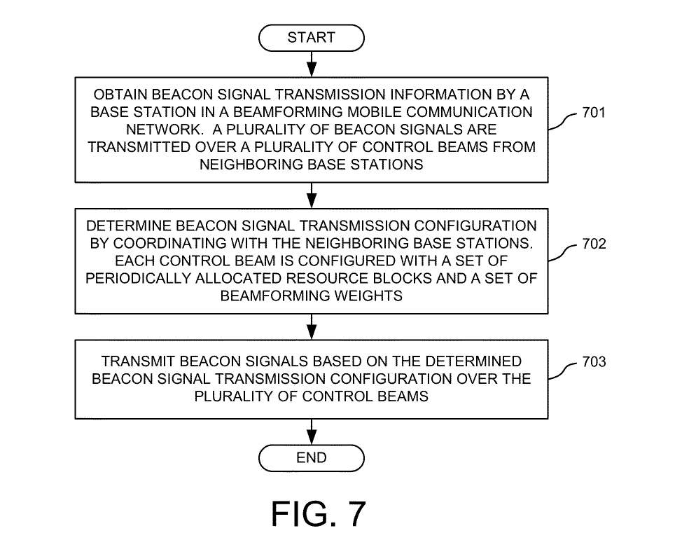

FIG. 7 is a flow chart of a method of inter-cell beam coordination in accordance with one novel aspect. In step 701, a base station obtains beacon signal transmission information in a beamforming mobile communication network. A plurality of beacon signals are transmitted over a plurality of control beams from neighboring base stations. In step 702, the base station determines beacon signal transmission configuration by coordinating with the neighboring base stations to minimize inter-cell beacon signal interference. Each control beam is configured with a set of periodically allocated resource blocks and a set of beamforming weights. In step 703, the base station transmits beacon signals based on the determined beacon signal transmission configuration over the plurality of control beams.

The beacon signal transmission information and configuration comprises beam pattern/ID information, a beacon period, and a beam sweeping order. In a first embodiment, the beacon signal transmission information is obtained based on a common external clock. In a second embodiment, the beacon signal transmission information is obtained from scanning the beacon signals from one of the neighboring base stations. In a third embodiment, the beacon signal transmission information is obtained from scanning the beacon signals from each of the neighboring base stations during an observation period. The base station detects radio signal quality or power information of each beacon signal and thereby determining a beacon period and a beam sweeping order to minimize inter-cell spatial interference among beacon signal transmissions from different cells.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
obtaining beacon signal transmission information by a base station in a beamforming mobile communication network, wherein a plurality of beacon signals are transmitted over a plurality of control beams from neighboring base stations;
determining beacon signal transmission configuration by coordinating with the neighboring base stations to minimize inter-cell beacon signal interference, wherein each control beam is configured with a set of periodically allocated resource blocks and a set of beamforming weights; and
transmitting beacon signals based on the determined beacon signal transmission configuration over the plurality of control beams.

2. The method of claim 1, wherein a collection of the plurality of control beams creates a radiation pattern that covers an entire service area of a cell.

3. The method of claim 1, wherein the beacon signal transmission information comprises beam pattern/ID information, a beacon period, and a beam sweeping order.

4. The method of claim 3, wherein the base station synchronizes with the neighboring base stations based on the beacon period and the beam sweeping order.

5. The method of claim 1, wherein the beacon signal transmission information is obtained based on a common external clock.

6. The method of claim 1, wherein the beacon signal transmission information is obtained from scanning the beacon signals from one of the neighboring base stations.

7. The method of claim 6, wherein the base station synchronizes with a beacon period and a beam sweeping order of the one neighboring base station.

8. The method of claim 1, wherein the beacon signal transmission information is obtained from scanning the beacon signals from each of the neighboring base stations during an observation period.

9. The method of claim 8, wherein the base station detects radio signal quality or power information of each beacon signal and thereby determining a beacon period and a beam sweeping order to minimize inter-cell spatial interference among beacon signal transmissions from different cells.

10. The method of claim 8, wherein the beacon signal transmissions are synchronous or asynchronous among different base stations.

11. A base station, comprising:
a receiver that obtains beacon signal transmission information by a base station in a beamforming mobile communication network, wherein a plurality of beacon signals are transmitted over a plurality of control beams from neighboring base stations;
a beam synchronization module that determines beacon signal transmission configuration by coordinating with the neighboring base stations to minimize inter-cell beacon signal interference, wherein each control beam is configured with a set of periodically allocated resource blocks and a set of beamforming weights; and
a transmitter that transmits beacon signals based on the determined beacon signal transmission configuration over the plurality of control beams.

12. The base station of claim 11, wherein a collection of the plurality of control beams creates a radiation pattern that covers an entire service area of a cell.

13. The base station of claim 11, wherein the beacon signal transmission information comprises beam pattern/ID information, a beacon period, and a beam sweeping order.

14. The base station of claim 13, wherein the base station synchronizes with the neighboring base stations based on the beacon period and the beam sweeping order.

15. The base station of claim 11, wherein the beacon signal transmission information is obtained based on a common external clock.

16. The base station of claim 11, wherein the beacon signal transmission information is obtained from scanning the beacon signals from one of the neighboring base stations.

17. The base station of claim 16, wherein the base station synchronizes with a beacon period and a beam sweeping order of the one neighboring base station.

18. The base station of claim 11, wherein the beacon signal transmission information is obtained from scanning the beacon signals from each of the neighboring base stations during an observation period.

19. The base station of claim 18, wherein the base station detects radio signal quality or power information of each beacon signal and thereby determining a beacon period and a beam sweeping order to minimize inter-cell spatial interference among beacon signal transmissions from different cells.

20. The base station of claim 18, wherein the beacon signal transmissions are synchronous or asynchronous among different base stations.
